(19) United States
(12) Patent Application Publication
(10) Pub. No.: US 2011/0157311 A1
(43) Pub. Date: Jun. 30, 2011

(54) Method and System for Rendering Multi-View Image

(75) Inventors: Ludovic Angot, Hsinchu City (TW); Wei-Hao Huang, Tainan City (TW); Wei-Jia Huang, Puli Township (TW); Kai-Che Liu, Kaohsiung City (TW)

(73) Assignee: INDUSTRIAL TECHNOLOGY RESEARCH INSTITUTE, Hsinchu (TW)

(21) Appl. No.: 12/752,600

(22) Filed: Apr. 1, 2010

(30) Foreign Application Priority Data
Dec. 31, 2009 (TW) 98146266

(51) Int. Cl. H04N 13/02; G06T 15/00

(52) U.S. Cl. 348/46; 345/419; 348/E13.074

(57) ABSTRACT

A method and a system for rendering a multi-view image are provided. The method for rendering the multi-view image includes the following steps. An image capturing unit provides an original image and depth information thereof. Multiple threads of one processing unit perform a pixel rendering process and a hole filling process on at least one row of pixels of the original image according to the depth information by way of parallel processing to render at least one new-view image. View-angles of the at least one new-view image and the original image are different. Each of the threads performs a view interlacing process on at least one pixel of the original image and the at least one new-view image by way of parallel processing to render the multi-view image.

This application claims the benefit of Taiwan application Serial No. 98146266, filed Dec. 31, 2009, the subject matter of which is incorporated herein by reference.

### BACKGROUND

1. Technical Field

The disclosure relates in general to a method and a system for rendering an image, and more particularly to a method and a system for rendering a multi-view image.

2. Description of the Related Art

The digital images have the advantages that no film is wasted, no spaced is occupied, no color fading occurs and the image data can be easily stored, carried and edited so that the digital images have gradually replaced the photos shot on the conventional film.

With the technological development of the digital imaging, various image editing techniques have been continuously developed. The photos can be glorified, some interesting patterns may be added thereto or even a multi-view stereoscopic image may be rendered through the image editing techniques.

However, the method of rendering the multi-view stereoscopic image is quite complicated. Some conventionally existing techniques need more effective processing speed.

### SUMMARY

According to the present disclosure, a method of rendering a multi-view image is provided. The method includes the following steps. An image capturing unit provides an original image and depth information of the original image. Several threads of a processing unit perform a pixel rendering process and a hole filling process on at least one row of pixels of the original image according to the depth information by way of parallel processing to render at least one new-view image. View-angles of the at least one new-view image and the original image are different. Each of the threads performs a view interlacing process on at least one pixel of the original image and the at least one new-view image by way of parallel processing to render the multi-view image.

According to the present disclosure, a system for rendering a multi-view image is also provided. The system includes an image capturing unit and a processing unit. The image capturing unit provides an original image and depth information of the original image. The processing unit has several threads. The threads perform a pixel rendering process and a hole filling process on at least one row of pixels of the original image according to the depth information by way of parallel processing to render at least one new-view image. View-angles of the at least one new-view image and the original image are different. The threads perform a view interlacing process on at least one pixel of the original image and the at least one new-view image by way of parallel processing to render the multi-view image.

The disclosure will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing an original image.

FIG. 2 is a schematic illustration showing different view-angles.

FIG. 3 is a schematic illustration showing a new-view image formed when a photographer moves rightward.

FIG. 4 is a schematic illustration showing a new-view image formed when the photographer moves leftward.

FIG. 5 shows the relationships among the original image, the new-view images and the multi-view image.

FIG. 6A is a schematic illustration showing a system for rendering a multi-view image according to the first embodiment of the disclosure.

FIG. 6B is a flow chart showing a method of rendering a multi-view image according to the first embodiment of the disclosure.

FIG. 7 is a schematic illustration showing two original images at left and right view-angles.

FIGS. 8A and 8B are schematic illustrations respectively showing directions of the pixel rendering process and the hole filling process adopted in a certain new-view image.

FIG. 9 is a schematic illustration showing the directions of the pixel rendering process and the hole filling process adopted in the new-view images of FIGS. 8A and 8B and finished in the same step.

FIG. 10 is a schematic illustration showing a view interlacing process performed on the original image and multiple new-view images according to the first embodiment of the disclosure.

FIG. 11 is a schematic illustration showing the view interlacing process performed on the left-eye view-angle image and the right-eye view-angle image according to a second embodiment of the disclosure.

FIG. 12 is a schematic illustration showing the view interlacing process performed on the original image and a new-view image according to a third embodiment of the disclosure.

FIG. 13 is a schematic illustration showing the view interlacing process performed using a programming interface system.

### DETAILED DESCRIPTION

The detailed descriptions will be made according to several illustrative but non-limiting embodiments. In addition, unessential elements will be omitted from the drawings in order to show the technological features of the present disclosure clearly.

### First Embodiment

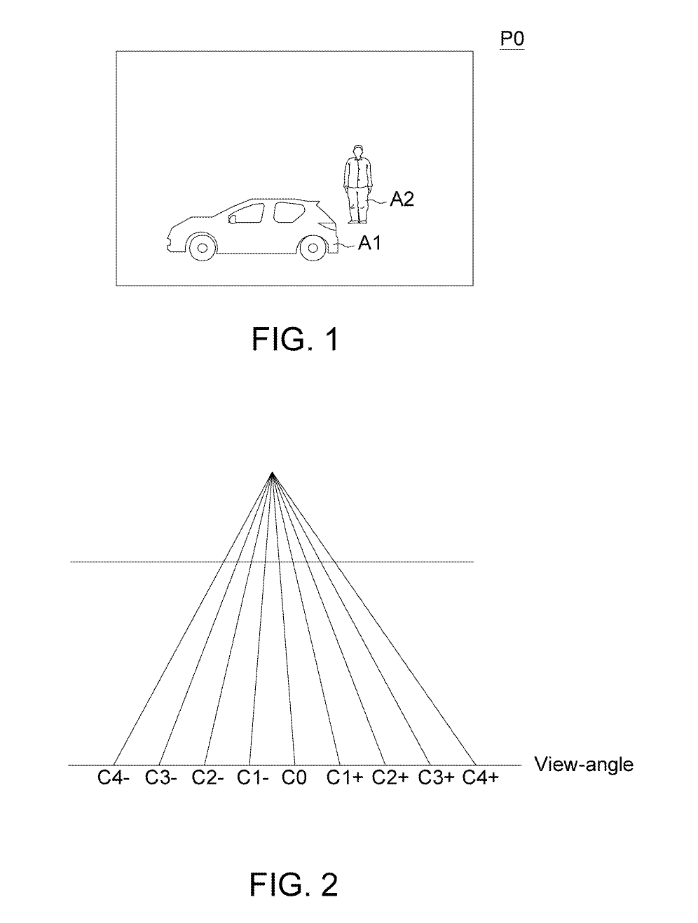

FIG. 1 is a schematic illustration showing an original image P0. When the photographer is photographing one original image P0 at a certain angle, the distances from the objects to the photographer are different from one another or each other. For example, the distance from the first object A1 of FIG. 1 to the photographer is the shortest distance, and the distance from the second object A2 to the photographer is the longest distance.

FIG. 2 is a schematic illustration showing different view-angles. The photographer photographs the original image P0 at the view-angle C0. When the photographer moves from the view-angles C1+ to C4+ or from the view-angles C1− to C4−, the first object A1 and the second object A2 move leftward and rightward on the frame.

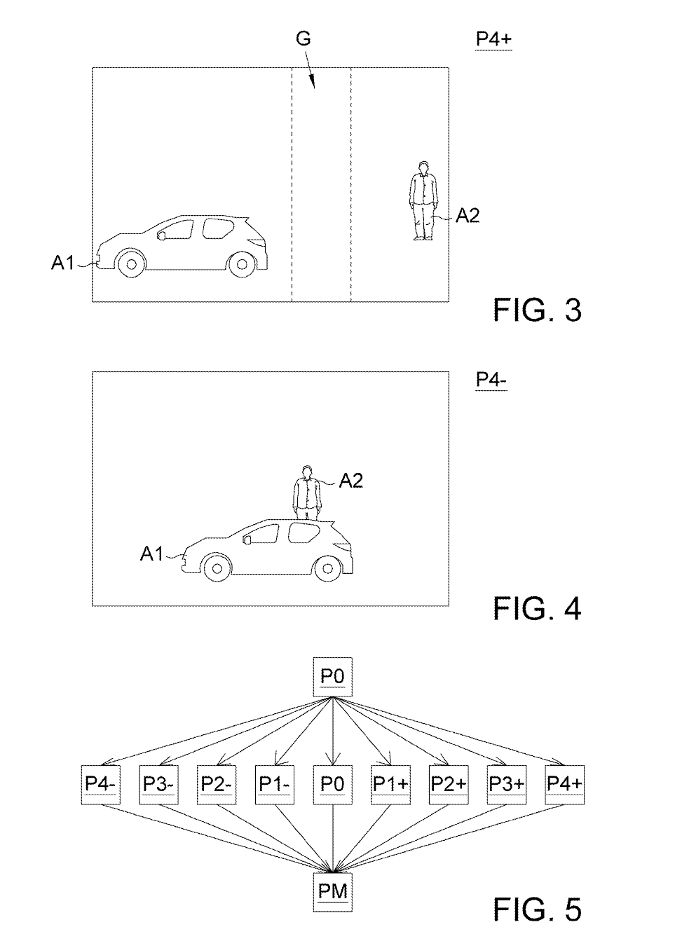

For example, FIG. 3 is a schematic illustration showing a new-view image P4+ formed when a photographer moves rightward. Because the first object A1 of FIG. 1 is close to the left side of the original image P0 and the second object A2 is close to the right side of the original image P0, the first object A1 moves leftward and the second object A2 moves rightward when the photographer moves rightward.

FIG. 4 is a schematic illustration showing a new-view image P4− formed when the photographer moves leftward. When the photographer moves leftward, the first object A1 moves rightward and the second object A2 moves leftward.

FIG. 5 shows the relationships between the original image P0, the new-view images P4−, P3−, P2−, P1−, P1+, P2+, P3+ and P4+ and the multi-view image PM. The pixel rendering process can render each pixel of the original image P0 to a proper position so that the new-view images P4−, P3−, P2−, P1−, P1+, P2+, P3+ and P4+ can be rendered. In the pixel rendering process, the new-view images P4−, P3−, P2−, P1−, P1+, P2+, P3+ and P4+ may encounter the phenomenon of the appearance of a gap G (see FIG. 3). At this time, the gap G may be filled through the hole filling process. Thereafter, a view interlacing process may be performed on the new-view images P4−, P3−, P2−, P1−, P1+, P2+, P3+ and P4+ and the original image P0 to render a multi-view image PM. That is, it is possible to see the images at different view-angles on a multi-view image PM.

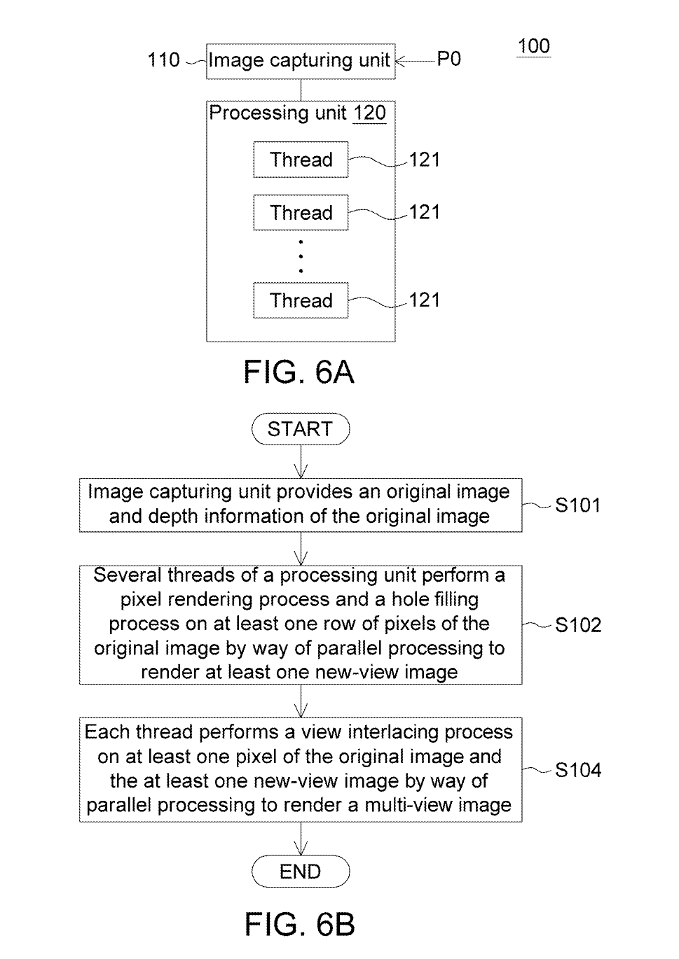

FIG. 6A is a schematic illustration showing a system 100 for rendering a multi-view image according to a first embodiment of the disclosure. Referring to FIG. 6A, the system 100 of rendering the multi-view image includes an image capturing unit 110 and a processing unit 120. The image capturing unit 110 is, for example, a camera, a camcorder or a connection port connected to an image storage medium. When the image capturing unit 110 is the camera or the camcorder, the original image P0 may be captured thereby in real-time. When the image capturing unit 110 is a connection port, the original image P0 may be stored into the image storage medium in advance and then captured through the connection port. The processing unit 120 may provide several threads 121. The processing unit 120 may be, for example, a combination of at least one single-core processor, a combination of at least one dual-core processor or a combination of at least one multi-core processor.

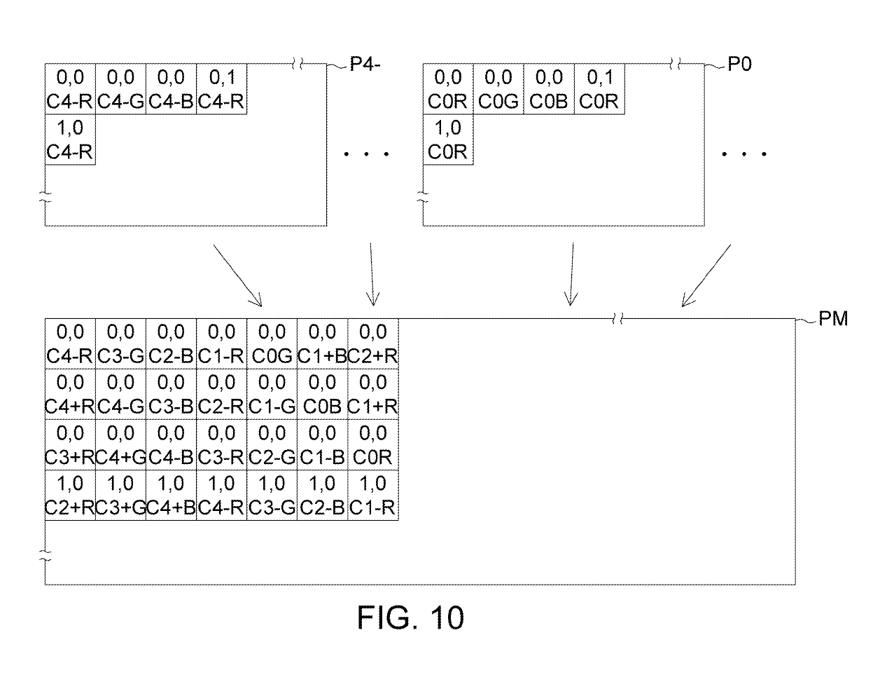

In this embodiment, the multi-view image PM (shown in FIG. 10) is rendered by way of parallel processing. FIG. 6B is a flow chart showing a method of rendering the multi-view image PM according to the first embodiment of the disclosure. The method of rendering the multi-view image PM of this embodiment will be described with reference to a flow chart.

First, in step S101, the image capturing unit 110 provides the original image P0 and the depth information of the original image P0.

Next, in step S102, the threads 121 of the processing unit 120 perform the pixel rendering process and the hole filling process on at least one row of pixels of the original image P0 according to the depth information by way of parallel processing to render at least one new-view image. In this illustrated embodiment, multiple new-view images P4−, P3−, P2−, P1−, P1+, P2+, P3+ and P4+ are rendered in this step.

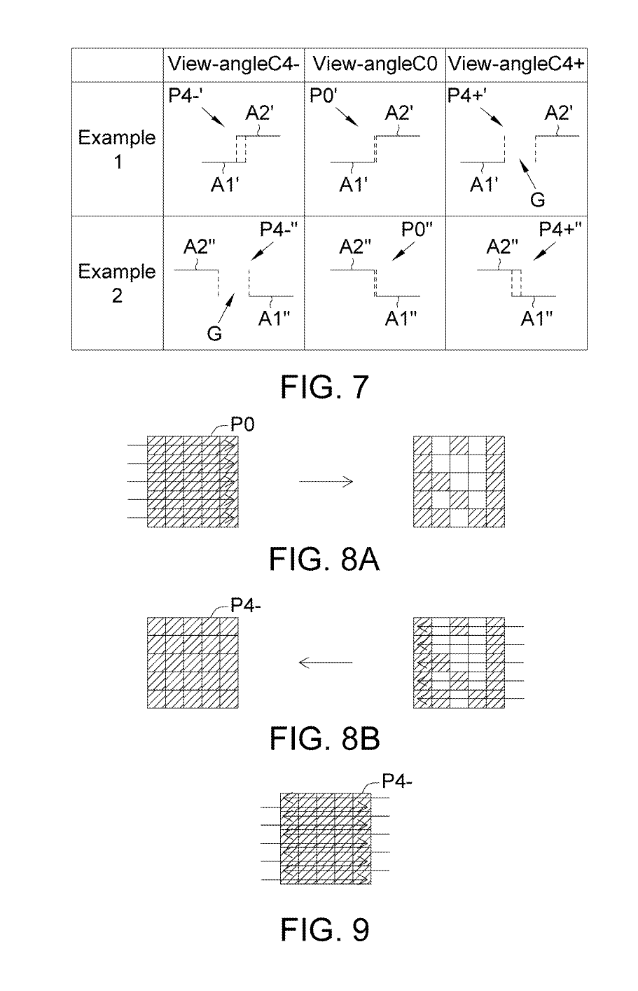

FIG. 7 is a schematic illustration showing two original images P0′ and P0″ at left and right view-angles. As shown in Example 1 of FIG. 7, the foreground object A1′ is located at the left side and the background object A2′ is located at the right side in the original image P0′ of the view-angle C0. When the photographer moves to the view-angle C4−, the foreground object A1′ and the background object A2′ approach each other. So, in the new-view image P4−′ of the view-angle C4−, an occluding effects may occur with respect to the foreground object A1′ and the background object A2′. In order to make the foreground object A1′ occlude the background object A2′, it is possible to firstly shift the background object A2′ of the original image P0′ and then the foreground object A1′ of the original image P0′ when the pixel rendering process is being performed. That is, the pixel rendering process is performed from right to left.

As shown in Example 1 of FIG. 7, when the photographer moves to the view-angle C4+, the foreground object A1′ is separated from the background object A2′ and thus a gap G is formed. Most of the contents within the gap G are from the background object A2′. So, when the hole filling process is being performed, the background object A2′ of the new-view image P4+′ may be firstly adopted to fill the gap G. That is, the hole filling process is performed from right to left.

As shown in Example 2 of FIG. 7, the foreground object A1″ is located at the right side and the background object A2″ is located at the left side in the original image P0″ of the view-angle C0. When the photographer moves to the view-angle C4−, the foreground object A1″ is separated from the background object A2″ to form the gap G. Most of the contents within the gap G are from the background object A2″. So, when the hole filling process is being performed, it is possible to firstly adopt the background object A2″ neighboring the gap G in the new-view image P4−″ to fill the gap G. That is, the hole filling process is performed from left to right.

As shown in Example 2 of FIG. 7, when the photographer moves to the view-angle C4+, the foreground object A1″ approaches the background object A2″ and thus an occluding effect occurs. In order to make the foreground object A1″ occlude the background object A2″, it is possible to firstly shift the background object A2″ of the original image P0″ and then the foreground object A1″ of the original image P0″ when the pixel rendering process is being performed. That is, the pixel rendering process is performed from left to right.

The pixel rendering process and the hole filling process may be demonstrated in the following Table 1.

TABLE 1

| | New | Process | Processing |
|---|---|---|---|
| Original image | view-angle | (processing effect) | direction |
| Foreground object is | C4− | Pixel rendering | From right to |
| located at left side, | | process (occluding | left |
| and background object | | effect) | |
| is located at right side | | | |
| Foreground object is | C4+ | Hole filling process | From right to |
| located at left side, | | (gap effect) | left |
| and background object | | | |
| is located at right side | | | |
| Foreground object is | C4− | Hole filling process | From left to |
| located at right side, | | (gap effect) | right |
| and background object | | | |
| is located at left side | | | |
| Foreground object is | C4+ | Pixel rendering | From left to |
| located at right side, | | process (occluding | right |
| and background object | | effect) | |
| is located at left side | | | |

In one original image, more than one Foreground object image and more than one background object image may appear. One Foreground object may be located at a left side of a certain background object, and may also simultaneously appear at the right side of another background object. Therefore, when the photographer moves to the new view-angle, the occluding effect and the gap effect may simultaneously appear. Therefore, the occluding effect and the gap effect have to be processed when the new-view image is rendered.

FIGS. 8A and 8B are schematic illustrations respectively showing directions of the pixel rendering process and the hole filling process adopted in a certain new-view image. According to Table 1, it is found that the pixel rendering process (see FIG. 8A) may be performed from right to left at the view-angle C4− and then the hole filling process (see FIG. 8B) is performed from left to right no matter how complicated the relationship between the object of the original image P0 is. Thus, all possible occluding effects and gap effects may be completely processed. FIG. 9 is a schematic illustration showing the directions of the pixel rendering process and the hole filling process adopted in the new-view image of FIGS. 8A and 8B and finished in the same step. Because the pixel rendering process and the hole filling process have reverse directions, the operations of the pixel rendering process and the hole filling process may be merged. Consequently, the pixel rendering process and the hole filling process may be finished in the same step.

In addition, it is possible to perform the pixel rendering process from left to right and then to perform the hole filling process from right to left at the view-angle C4+. Similarly, because the pixel rendering process and the hole filling process have reverse directions, the operations of the pixel rendering process and the hole filling process may be merged. Consequently, the pixel rendering process and the hole filling process may be finished in the same step.

Therefore, in this step, each thread 121 only needs to perform the pixel rendering process in one direction and then to perform the hole filling process in another direction reverse to the direction of pixel rendering process so that the pixel rendering process and the hole filling process may be finished in the same step.

In addition, this embodiment adopts multiple threads 121 to perform the pixel rendering process and the hole filling process. Each thread 121 may correspond to one row or several rows of pixels. Each thread 121 may simultaneously process the pixel rendering process and the hole filling process to increase the processing speed. If the number of threads 121 is the number of rows of the original image P0, then each thread 121 corresponds to one row of the original image P0 so that each row of the original image P0 may simultaneously perform the pixel rendering process and the hole filling process.

Furthermore, multiple new-view images at different view-angles may be rendered according to one original image P0. If the number of threads 121 is the product of the number of rows of the original image and the number of the new-view images P4−, P3−, P2−, P1−, P1+, P2+, P3+ and P4+, then the pixel rendering process and the hole filling process may be simultaneously performed on each row of each of the new-view images P4−, P3−, P2−, P1−, P1+, P2+, P3+ and P4+.

Then in step S104, each thread 121 performs a view interlacing process on at least one pixel of the original image P0 and the new-view images P4−, P3−, P2−, P1−, P1+, P2+, P3+ and P4+ by way of parallel processing to render one multi-view image PM.

FIG. 10 is a schematic illustration showing the view interlacing process performed on the original image P0 and multiple new-view images P4−, P3−, P2−, P1−, P1+, P2+, P3+ and P4+ according to the first embodiment of the disclosure. As shown in FIG. 10, (0,0,C4−,R) represents the red pixel of the new-view image P4− of the view-angle C4− at the coordinates (0,0), (0,0,C4−,G) represents the green pixel of the new-view image P4− of the view-angle C4− at the coordinates (0,0), (0,0,C4−,B) represents the blue pixel of the new-view image P4− of the view-angle C4− at the coordinates (0,0), and so on. The pixels of the original image P0 and the new-view images P4−, P3−, P2−, P1−, P1+, P2+, P3+ and P4+ are arranged in a stairs-like structure to constitute one multi-view image PM.

The multi-view image PM is arranged in a manner determined according to the resolution of the display, the view-angles selected, the position selected in the new-view image and the colors selected. This embodiment adopts multiple threads 121 to process the view interlacing processes in parallel. If the number of threads 121 is a product of the number of rows of the multi-view image PM, the number of columns of the multi-view image PM and the number of primary colors, then the view interlacing processes on the pixels of the multi-view image PM may be simultaneously finished.

After the view interlacing process of the first embodiment is performed, the saw-tooth effect may be generated. Therefore, the resolutions of each new-view image and the final multi-view image PM may be adjusted to be the same, and then the view interlacing process is performed. Consequently, the saw-tooth effect may be effectively reduced.

For example, when the resolutions of each new-view image and the final multi-view image PM are adjusted to be the same, the pixel positions of the multi-view image PM may directly correspond to the pixel positions of each new view-angle to reduce the saw-tooth effect.

### Second Embodiment

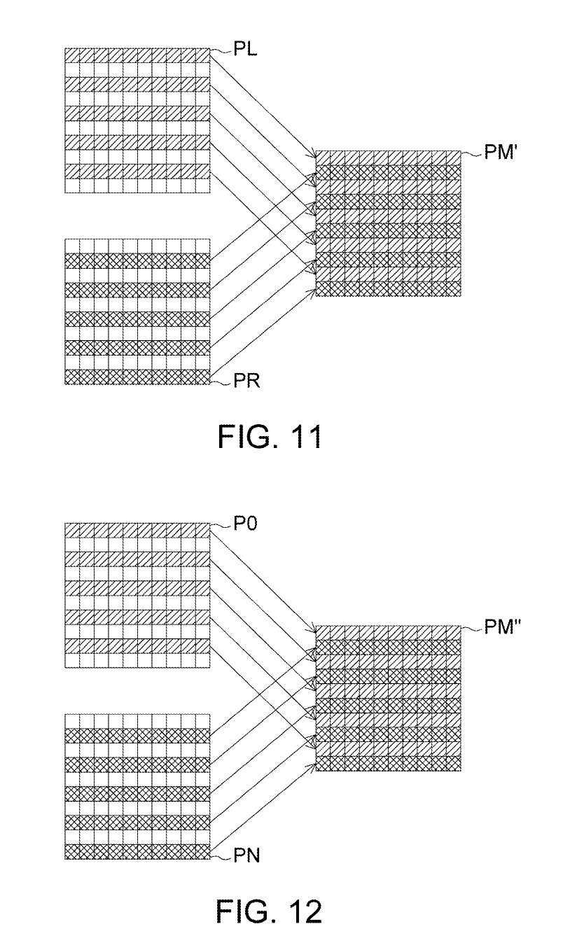

FIG. 11 is a schematic illustration showing the view interlacing process performed on the left-eye view-angle image PL and the right-eye view-angle image PR according to a second embodiment of the disclosure. As shown in FIG. 11, the second embodiment is the same as the first embodiment except for the difference that the images at two different view-angles are adopted to constitute a multi-view image, wherein the descriptions of the second embodiment the same as the first embodiment will be omitted.

As shown in FIG. 11, the threads 121 arrange the odd-numbered rows of the left-eye view-angle image PL to the odd-numbered rows of the multi-view image PM′, and arrange the even-numbered rows of the right-eye view-angle image PR to the even-numbered rows of the multi-view image PM′. Consequently, the user may use left and right polariscopes to view the stereoscopic image.

In another embodiment, these threads 121 may also arrange the odd-numbered rows of the left-eye view-angle image PL to the even-numbered rows of the multi-view image PM′, and arrange the even-numbered rows of the right-eye view-angle image PR to the odd-numbered rows of the multi-view image PM′. Adopting such a method may also achieve the effect of generating the stereoscopic image.

In still another embodiment, the threads 121 may also arrange the even-numbered rows of the left-eye view-angle image PL to the even-numbered rows of the multi-view image PM′, and arrange the odd-numbered rows of the right-eye view-angle image PR to the odd-numbered rows of the multi-view image PM′. Adopting such a method may also achieve the effect of generating the stereoscopic image.

In yet still another embodiment of the disclosure, the threads 121 may also arrange the even-numbered rows of the left-eye view-angle image PL to the odd-numbered rows of the multi-view image PM′, and arrange the odd-numbered rows of the right-eye view-angle image PR to the even-numbered rows of the multi-view image PM′. Adopting such a method may also achieve the effect of generating the stereoscopic image.

FIG. 12 is a schematic illustration showing the view interlacing process performed on the original image P0 and a new-view image PN according to a third embodiment of the disclosure. In this embodiment, the threads 121 may also constitute one multi-view image PM″ according to the original image P0 and the new-view image PN. As shown in FIG. 12, the threads 121 arrange the odd-numbered rows of the original image P0 to the odd-numbered rows of the multi-view image, and arrange the even-numbered rows of the new-view image PN to the even-numbered rows of the multi-view image PM″. Consequently, the user may use left and right polariscopes to view the stereoscopic image.

In another embodiment, the threads 121 may also arrange the odd-numbered rows of the original image P0 to the even-numbered rows of the multi-view image PM″, and arrange the even-numbered rows of the new-view image PN to the odd-numbered rows of the multi-view image PM″. Adopting such a method may also achieve the effect of generating the stereoscopic image.

In still another embodiment, the threads 121 may also arrange the even-numbered rows of the original image P0 to the even-numbered rows of the multi-view image PM″, and arrange the odd-numbered rows of the new-view image PN to the odd-numbered rows of the multi-view image PM″. Adopting such a method may also achieve the effect of generating the stereoscopic image.

In yet still another embodiment, the threads 121 may also arrange the even-numbered rows of the original image P0 to the odd-numbered rows of the multi-view image PM″, and arrange the odd-numbered rows of the new-view image PN to the even-numbered rows of the multi-view image PM″. Adopting such a method may also achieve the effect of generating the stereoscopic image.

In this embodiment, the pixels neighboring the gap may be used to fill the gap in the hole filling process. So, it is possible to perform the hole filling process and the view interlacing process simultaneously.

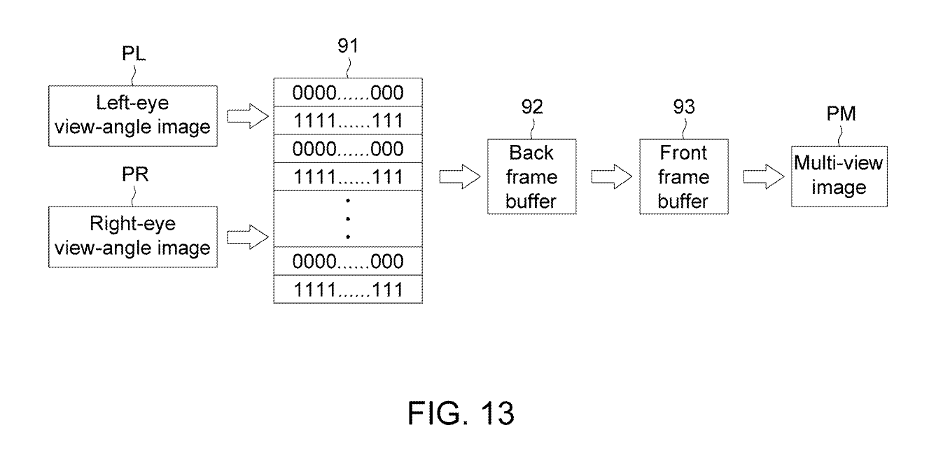

This embodiment adopting the images at two different view-angles to constitute one multi-view image may utilize a programming interface system to speed up the view interlacing process. The programming interface system may be, for example, the OpenGL (Open Graphics Library). FIG. 13 is a schematic illustration showing the view interlacing process performed using the programming interface system. In the following descriptions, the left-eye view-angle image PL and the right-eye view-angle image PR are illustrated as examples. First, the threads 121 display the left-eye view-angle image PL and the right-eye view-angle image PR to the stencil buffer 91 of the OpenGL. The left-eye view-angle image PL is displayed to the channel 0, and the right-eye view-angle image PR is displayed to the channel 1. Then, the data of the stencil buffer 91 is depicted to the back frame buffer 92 of the OpenGL. Next, the threads 121 further swap the data of the back frame buffer 92 to the front frame buffer 93. Then, the threads 121 can display the multi-view image PM rendered after the view interlacing process.

Although the operation of the programming interface system is described according to the examples of the left-eye view-angle image PL and the right-eye view-angle image PR, the programming interface system may also be applied to the new-view image PN and the original image P0.

Generally, the above disclosure is directed to a method and a system for rendering a multi-view image, in which the speed of processing the multi-view image is increased by way of parallel processing.

While the disclosure has been described by way of examples and in terms of preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of rendering a multi-view image, the method comprising:
providing, by an image capturing unit, an original image and depth information of the original image;
performing, by a plurality of threads of a processing unit, a pixel rendering process and a hole filling process on at least one row of pixels of the original image according to the depth information by way of parallel processing to render at least one new-view image, wherein view-angles of the at least one new-view image and the original image are different; and
performing, by the threads, a view interlacing process on at least one pixel of the original image and the at least one new-view image by way of parallel processing to render the multi-view image.

2. The method according to claim 1, wherein each of the threads performs the pixel rendering process and the hole filling process in the same step.

3. The method according to claim 1, wherein each of the threads performs the pixel rendering process in a direction, and each of the threads performs the hole filling process in another direction reverse to the direction.

4. The method according to claim 1, wherein when the at least one new-view image comprises a right side view-angle image of the original image, each of the threads performs the pixel rendering process from left to right.

5. The method according to claim 1, wherein when the at least one new-view image comprises a left side view-angle image of the original image, each of the threads performs the pixel rendering process from right to left.

6. The method according to claim 1, wherein when the at least one new-view image comprises a right side view-angle image of the original image, each of the threads performs the hole filling process from right to left.

7. The method according to claim 1, wherein when the at least one new-view image comprises a left side view-angle image of the original image, each of the threads performs the hole filling process from left to right.

8. The method according to claim 1, wherein the number of the threads is determined according to the number of rows of the original image and the number of the at least one new-view image.

9. The method according to claim 1, wherein the number of the threads is a product of the number of rows of the original image and the number of the at least one new-view image.

10. The method according to claim 1, wherein the number of the threads is determined by the number of rows of the multi-view image, the number of columns of the multi-view image and the number of primary colors.

11. The method according to claim 1, wherein the number of the threads is a product of the number of rows of the multi-view image, the number of columns of the multi-view image and the number of primary colors.

12. The method according to claim 1, wherein the at least one new-view image comprises a left-eye view-angle image and a right-eye view-angle image, and in the step of performing the view interlacing process, a plurality of odd-numbered rows of the left-eye view-angle image and a plurality of even-numbered rows of the right-eye view-angle image are respectively interlaced to form the multi-view image.

13. The method according to claim 1, wherein the at least one new-view image comprises a left-eye view-angle image and a right-eye view-angle image, and in the step of performing the view interlacing process, a plurality of even-numbered rows of the left-eye view-angle image and a plurality of odd-numbered rows of the right-eye view-angle image are respectively interlaced to form the multi-view image.

14. The method according to claim 1, wherein in the step of performing the view interlacing process, a plurality of even-numbered rows of the at least one new-view image and a plurality of odd-numbered rows of the original image are respectively interlaced to form the multi-view image.

15. The method according to claim 1, wherein in the step of performing the view interlacing process, a plurality of odd-numbered rows of the at least one new-view image and a plurality of even-numbered rows of the original image are respectively interlaced to form the multi-view image.

16. The method according to claim 1, wherein the at least one new-view image comprises a left-eye view-angle image and a right-eye view-angle image, and the step of performing the view interlacing process comprises:
displaying, by the threads, the left-eye view-angle image and the right-eye view-angle image to a stencil buffer;
depicting, by the threads, data of the stencil buffer to a back frame buffer; and
swapping, by the threads, data of the back frame buffer to a front frame buffer.

17. The method according to claim 1, wherein the step of performing the view interlacing process comprises:
displaying, by the threads, the new-view image and the original image to a stencil buffer;
depicting, by the threads, data of the stencil buffer to a back frame buffer; and
swapping, by the threads, data of the back frame buffer to a front frame buffer.

18. A system for rendering a multi-view image, the system comprising:
an image capturing unit for providing an original image and depth information of the original image; and
a processing unit having a plurality of threads, wherein the threads perform a pixel rendering process and a hole filling process on at least one row of pixels of the original image according to the depth information by way of parallel processing to render at least one new-view image, wherein view-angles of the at least one new-view image and the original image are different, and the threads perform a view interlacing process to render the multi-view image on at least one pixel of the original image and the at least one new-view image by way of parallel processing.

19. The system according to claim 18, wherein each of the threads finishes the pixel rendering process and the hole filling process in the same step.

20. The system according to claim 18, wherein each of the threads performs the pixel rendering process in a direction, and each of the threads performs the hole filling process in another direction reverse to the direction.

21. The system according to claim 18, wherein when the at least one new-view image comprises a right side view-angle image of the original image, each of the threads performs the pixel rendering process from left to right.

22. The system according to claim 18, wherein when the at least one new-view image comprises a left side view-angle image of the original image, each of the threads performs the pixel rendering process from right to left.

23. The system according to claim 18, wherein when the at least one new-view image comprises a right side view-angle image of the original image, each of the threads performs the hole filling process from right to left.

24. The system according to claim 18, wherein when the at least one new-view image comprises a left side view-angle image of the original image, each of the threads performs the hole filling process from left to right.

25. The system according to claim 18, wherein the number of the threads relates to the number of rows of the original image and the number of the at least one new-view image.

26. The system according to claim 18, wherein the number of the threads is a product of the number of rows of the original image and the number of the at least one new-view image.

27. The system according to claim 18, wherein the number of the threads relates to the number of rows of the multi-view image, the number of columns of the multi-view image and the number of primary colors.

28. The system according to claim 18, wherein the number of the threads is a product of the number of rows of the multi-view image, the number of columns of the multi-view image and the number of primary colors.

29. The system according to claim 18, wherein the at least one new-view image comprises a left-eye view-angle image and a right-eye view-angle image, and the threads respectively interlace and arrange a plurality of odd-numbered rows of the left-eye view-angle image and a plurality of even-numbered rows of the right-eye view-angle image to form the multi-view image.

30. The system according to claim 18, wherein the at least one new-view image comprises a left-eye view-angle image and a right-eye view-angle image, and the threads respectively interlace and arrange a plurality of even-numbered rows of the left-eye view-angle image and a plurality of odd-numbered rows of the right-eye view-angle image to form the multi-view image.

31. The system according to claim 18, wherein the threads respectively interlace and arrange a plurality of even-numbered rows of the at least one new-view image and a plurality of odd-numbered rows of the original image to form the multi-view image.

32. The system according to claim 18, wherein the threads respectively interlace and arrange a plurality of odd-numbered rows of the at least one new-view image and a plurality of even-numbered rows of the original image to form the multi-view image.

33. The system according to claim 18, wherein:
the at east one new-view image comprises a left-eye view-angle image and a right-eye view-angle image;
the threads display the left-eye view-angle image and the right-eye view-angle image to a stencil buffer;
the threads depict data of the stencil buffer to a back frame buffer; and
the threads swap data of the back frame buffer to a front frame buffer.

34. The system according to claim 18, wherein:
the threads display the at least one new-view image and the original image to a stencil buffer;
the threads depict data of the stencil buffer to a back frame buffer; and
the threads swap data of the back frame buffer to a front frame buffer.
